(19) United States
(12) Patent Application Publication
(10) Pub. No.: US 2009/0265625 A1
(43) Pub. Date: Oct. 22, 2009

(54) IMAGE PROCESSING APPARATUS CAPABLE OF PREVIEW DISPLAY, IMAGE PROCESSING METHOD, AND COMPUTER-READABLE MEDIUM STORING IMAGE PROCESSING PROGRAM

(75) Inventors: Yoshiyuki Tamai, Itami-shi (JP); Hisashi Uchida, Kuze-gun (JP); Kazusei Takahashi, Nishinomiya-shi (JP); Masaya Hashimoto, Itami-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies Inc., Chiyoda-ku (JP)

(21) Appl. No.: 12/336,016

(22) Filed: Dec. 16, 2008

(30) Foreign Application Priority Data
Apr. 17, 2008 (JP) 2008-107830

(51) Int. Cl. G06F 17/00; G06F 3/12

(52) U.S. Cl. 715/274; 358/1.15

(57) ABSTRACT

A display controller displays a page selection menu generated by a page-selection-menu generator for selecting pages having a specific attribute based on contents of setting relating to printing in common. As one example, when both-side print setting is made, as a specific attribute based on the contents of the setting relating to the printing, an odd pages and even pages are displayed in a selectable manner among pages included in a preview image

This application is based on Japanese Patent Application No. 2008-107830 filed with the Japan Patent Office on Apr. 17, 2008, the entire content of which is hereby incorporated by reference.

### BACKGROUND OF THE INVENTION

1. Field of the Invention

The present invention relates to an image processing apparatus, an image processing method, and a computer-readable medium storing an image processing program, which are capable of displaying a preview of a print image obtained from an input image, and particularly to a constitution in which setting relating to print output can be changed over a plurality of pages.

2. Description of the Related Art

With recent progress of information and communication technology, the amount of print-outputted paper has increased. Meanwhile, it is preferable in view of environment to reduce wasteful print output as much as possible, thereby achieving resource saving. Therefore, among image forming apparatuses such as a multi function peripheral (hereinafter, also referred to as “MFP”), there is one with a function of displaying a print image before print-outputting the image on paper, so-called preview function.

For example, in Japanese Laid-Open Patent Publication No. 10-042087, there is disclosed an image processing apparatus having edition display means for displaying an image edited by edition operation. Moreover, in US 2007/0070470A1, there is disclosed an image processing apparatus including a transparent-finished-image generating unit that generates, when a target image extends to a plurality of pages, a transparent finished image by adjusting a transparency of a non-image portion of each of the pages of the finished image to a predetermined transparency, and a transparent-finished-image display unit that forms the transparent finished image in a stack, and displays the stacked transparent finished image on display means in such a manner that an image portion of the transparent finished image is seen through the non-image portion.

Here, “finishing processing” includes processing such as formation of punch holes and stapling for print-outputted paper The contents of such finishing processing (type, position and the like) are arbitrarily set and changed by a user. That is, the user adjusts various settings so as to obtain desired print output, referring to a print image displayed in preview.

Moreover, for change in setting, in Japanese Laid-Open Patent Publication No. 2005-268906, there is disclosed an image forming apparatus capable of collectively correcting scan errors.

For example, when both-side printing is performed on paper for output, setting of finishing processing will be different between a front surface and a back surface, that is, between an odd page and an even page. Therefore, for the user to make setting for odd pages and for even pages, it cannot help but select a target page individually and change the setting for each page.

Thus, in the conventional constitution, when a print output includes setting for a plurality of pages, there is a problem in that a user has to change for each page in this setting which takes time and effort.

### SUMMARY OF THE INVENTION

The present invention is intended to solve the above-described problem, and an object thereof is to provide an image processing apparatus, an image processing method, and a computer-readable medium storing an image processing program, which are capable of easily changing setting for print output including setting of a plurality of pages.

An image processing apparatus according to an aspect of the present invention includes a receiver for receiving setting relating to print output; and a display for displaying a print image when an input image is print-outputted in accordance with the setting. The display displays, in addition to the print image, an area for selecting pages having a specific attribute based on a content of the setting in common among pages included in the print image. The receiver, when a user operates the area, reflects setting inputted subsequently after the operation of the relevant area on the corresponding pages.

Preferably, the display provides a print image in accordance with the setting inputted subsequently after the selection in the area.

Preferably, the setting includes finishing setting for print-outputted paper.

Preferably, the setting includes setting for assembling a plurality of pages included in the input image in a single page to print-out the same.

Preferably, the area displayed in the display includes an area in which an odd page and an even page can be selected respectively among the pages included in the print image.

Preferably, when the input image includes a plurality of pages having different sizes, the area displayed in the display includes an area in which the page included in the print image can be selected by the image size.

Preferably, when the input image includes a plurality of pages having different image directions, the area displayed in the display includes an area in which the page included in the print image can be selected by the image direction.

Preferably, when the input image includes a color image and a monochrome image, the area displayed in the display includes an area in which the color image and the monochrome image can be selected respectively among the pages included in the print image.

An image processing method according to another aspect of the present invention includes the steps of receiving setting relating to print output, and displaying a print image when an input image is print-outputted in accordance with the setting, in a display The step of displaying includes the step of displaying an area for selecting pages having a specific attribute based on a content of the setting in common among pages included in the print image, in addition to the print image. The step of receiving includes the step of reflecting, in response to user operation of the area, setting inputted subsequently after the operation of the relevant area on the corresponding pages.

Preferably, the step of displaying further includes the step of redisplaying a print image in accordance with the setting inputted subsequently after the selection in the area.

Preferably, the setting includes finishing setting for print-outputted paper.

Preferably, the setting includes setting for assembling a plurality of pages included in the input image in a single page to print-out the same.

Preferably, the displayed area includes an area in which an odd page and an even page can be selected respectively among the pages included in the print image.

Preferably, when the input image includes a plurality of pages having different sizes, the displayed area includes an area in which the page included in the print image can be selected by the image size.

Preferably, when the input image includes a plurality of pages having different image directions, the displayed area includes an area in which the page included in the print image can be selected by the image direction.

Preferably, when the input image includes a color image and a monochrome image, the displayed area includes an area in which the color image and the monochrome image can be selected respectively among the pages included in the print image.

According to still another aspect of the present invention, there is provided a computer-readable medium that stores an image processing program to be executed in a computer connected to an input device and a display. A processor of the computer, in response to commands from the program, executes the steps of receiving setting relating to print output through the input device, and displaying a print image when an input image is print-outputted in accordance with the setting, in the display. The step of displaying includes the step of displaying an area for selecting pages having a specific attribute based on a content of the setting in common among pages included in the print image, in addition to the print image. The step of receiving includes the step of reflecting, in response to user operation of the area, setting inputted subsequently after the operation of the relevant area on the corresponding pages.

Preferably, the step of displaying further includes the step of redisplaying a print image in accordance with the setting inputted subsequently after the selection in the area.

Preferably, the setting includes finishing setting for print-outputted paper.

Preferably, the setting includes setting for assembling a plurality of pages included in the input image in a single page to print-out the same.

Preferably, the displayed area includes an area in which an odd page and an even page can be selected respectively among the pages included in the print image.

Preferably, when the input image includes a plurality of pages having different sizes, the displayed area includes an area in which the page included in the print image can be selected by the image size.

Preferably, when the input image includes a plurality of pages having different image directions, the displayed area includes an area in which the page included in the print image can be selected by the image direction.

Preferably, when the input image includes a color image and a monochrome image, the displayed area includes an area in which the color image and the monochrome image can be selected respectively among the pages included in the print image.

According to the present invention, in the print output including the setting for a plurality of pages, the setting can be easily changed.

The foregoing and other objects, features, aspects and advantages of the present invention will become more apparent from the following detailed description of the present invention when taken in conjunction with the accompanying drawings

### BRIEF DESCRIPTION OF THE DRAWINGS

FIG. 1 is a schematic diagram showing a schematic hardware configuration in an MFP according to an embodiment of the present invention.

FIG. 2 is a diagram showing a representative outer appearance of an operation panel of the MFP according to the embodiment of the present invention.

FIG. 3 is a block diagram showing a control structure in the MFP according to the embodiment of the present invention.

FIGS. 4A and 4B are diagrams for illustrating examples of processing according to the embodiment of the present invention.

FIGS. 5A and 5B are diagrams for illustrating examples of assembled printing according to the embodiment of the present invention.

FIG. 6 is a diagram for illustrating one example of one-side/both-side print setting and print position/direction setting according to the embodiment of the present invention.

FIG. 7 is a diagram for illustrating one example of stamp processing according to the embodiment of the present invention.

FIG. 8 is a flowchart showing overall processing in the MFP according to the embodiment of the present invention.

FIG. 9 is a diagram showing an example in a single-page display mode of a preview screen according to the embodiment of the present invention.

FIG. 10 is a diagram showing an example in a list display mode of the preview screen according to the embodiment of the present invention (in case of both-side printing and finishing setting).

FIG. 11 is a diagram showing an example of the setting change screen according to the embodiment of the present invention (in case of finishing setting).

FIG. 12 is a diagram showing an example in the list display mode of the preview screen according to the embodiment of the present invention (in case of assembled print setting).

FIG. 13 is a diagram showing an example in the setting change screen according to the embodiment of the present invention (in case of assembled print setting).

FIG. 14 is a diagram showing an example in the list display mode of the preview screen according to the embodiment of the present invention (in the case where longitudinally long document(s) and laterally long document(s) are mixed and in case of stamp setting).

FIG. 15 is a diagram showing an example of the setting change screen according to the embodiment of the present invention (in the case where longitudinally long document(s) and laterally long document(s) are mixed and in case of stamp setting).

FIG. 16 is a diagram showing an example in the list display mode of the preview screen according to the embodiment of the present invention (in the case where a plurality of image sizes are mixed and in case of both-side print setting).

FIG. 17 is a diagram showing an example of the setting change screen according to the embodiment of the present invention (in the case where a plurality of image sizes are mixed and in case of both-side print setting).

FIG. 18 is a diagram showing an example in the list display mode of the preview screen according to the embodiment of the present invention (in the case where monochrome image and color image are mixed and in case of stamp setting).

FIG. 19 is a diagram showing an example of the setting change screen according the embodiment of the present invention (in the case where monochrome image and color image are mixed and in case of stamp setting).

FIG. 20 is a diagram showing an example in the list display mode of the preview screen according to the embodiment of the present invention (in case of setting of a plurality of items).

FIG. 21 is a diagram showing an example of a submenu in the preview screen shown in FIG. 20.

FIG. 22 is a flowchart showing more detailed processing contents in preview display processing in step S8 shown in FIG. 8.

FIG. 23 is a flowchart showing more detailed contents of page-selection-menu generating processing in step S116 in FIG. 22.

FIG. 24 is a flowchart showing more detailed contents of page-selection receiving processing in step S120 in FIG. 22.

FIG. 25 is a flowchart showing more detailed contents of reflection processing of setting change in step S128 in FIG. 22.

FIG. 26 is a schematic configuration diagram of a system according to another embodiment of the present invention.

FIG. 27 is a schematic diagram showing a schematic hardware configuration of a personal computer according to the other embodiment of the present invention.

### DESCRIPTION OF THE PREFERRED EMBODIMENTS

Referring to the drawings, the embodiments of the present invention are described in detail. For the same or corresponding parts in figures, the same reference numerals are given and their descriptions are not repeated.

<Apparatus Configuration>

In an embodiment of the present invention, as a representative example of an image processing apparatus according to the present invention is described a multi function peripheral (hereinafter, also referred to as MFP) having a plurality of functions such as a copy function (monochrome and/or color), print function, FAX transmission/reception function, and image scanning function. As described later, the image processing apparatus according to the present invention may be implemented by a personal computer or the like.

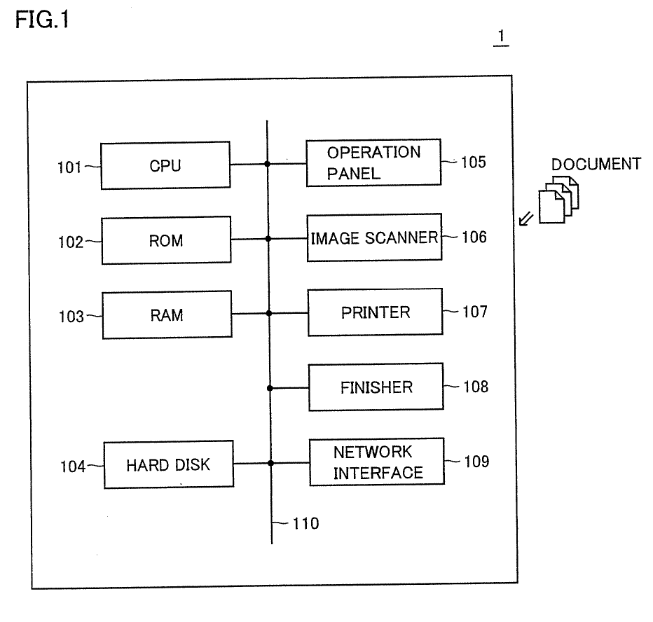

Referring to FIG. 1, an MFP 1 according to the embodiment of the present invention includes a CPU (Central Processing Unit) 101, a ROM (Read Only Memory) 102, a RAM (Random Access Memory) 103, a hard disk 104, an operation panel 105, an image scanner 106, a printer 107, a finisher 108, and a network interface 109, and the respective units are interconnected through a bus 110.

CPU 101 is a processor that provides an image processing method according to the embodiment by reading out, in RAM 103, a program stored in ROM 102, hard disk 104 or the like in advance to execute the same. ROM 102 stores the program to be executed in CPU 101, various setting values and the like in a nonvolatile manner. RAM 103 is a storage device representatively including DRAM (Dynamic Random Access Memory), holding the program to be executed in CPU 101, data necessary for the execution of the program, and the like. Hard disk 104 is a storage medium capable of storing an image scanned by image scanner 106, and an image inputted externally through a network or the like.

Operation panel 105 is a user interface for receiving various user operations and displaying various types of information to a user.

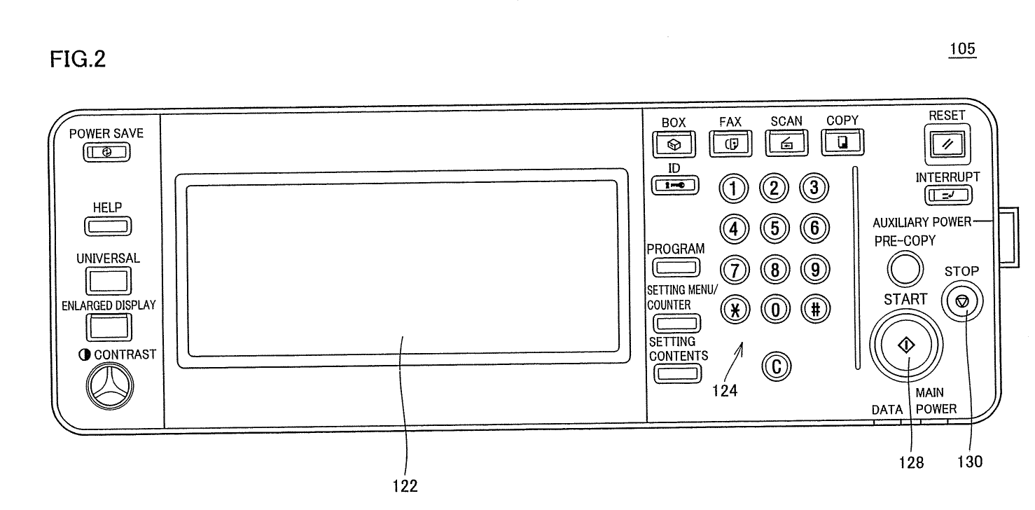

Referring to FIG. 2, operation panel 105 of MFP 1 according to the embodiment includes a plurality of operation keys such as ten keys 124, a start key 128 and a stop key 130, and a touch panel 122.

When the user presses start key 128, a function having been selected in MFP 1 is executed, and when the user presses stop key 130, a function being executed is ceased or stopped.

Touch panel 122 includes a liquid crystal display (LCD) for displaying various types of information in MFP 1, and a pressure-sensitive panel that receives a user operation by sensing its pressure. More specifically, in touch panel 122, various types of information are displayed to the user, and buttons and icons for receiving respective operations to MFP 1 are displayed. When the pressure-sensitive panel senses that a user operation is performed in a position corresponding to any of the buttons, a command corresponding to that button is issued to CPU 101 and the like.

Again, referring to FIG. 1, image scanner 106 scans image information from a document to generate an image. More specifically, image scanner 106 irradiates light from a light source to the document placed on a platen glass, and receives the light reflected from the document by an image pickup element or the like to thereby obtain the image information of the document. Alternatively, image scanner 106 may include a document feeder tray, a delivery roller, a resist roller, a carrier roller, a paper discharge tray, and the like so as to enable continuous document scanning. The image generated from the image information obtained by image scanner 106 is stored in hard disk 104 or the like.

Printer 107 print-outputs the image stored in hard disk 104 or the like on paper according to the user operation from operation panel 105. More specifically, printer 107 includes a photoreceptor drum, a charger, an exposure unit, a developing unit, a transfer unit, a static eliminator, a fixing device, a cleaning device and the like, and these mechanisms operate in series to thereby provide print processing.

Herein, an image to be print-outputted on paper by printer 107 is also referred to as “input image”. The generation/acquisition of the “input image” may be achieved by any method. Representatively, the input image includes an image obtained by image scanner 106 of MFP 1 itself, a FAX image received by MFP 1 itself over a telephone line or the like, an image transmitted from another MFP or a personal computer, and the like. In some cases, the image transmitted from the personal computer may be generated by a document creating application executed by the personal computer.

Finisher 108 is arranged downstream of printer 107, and performs various types of finishing processing for the paper print-outputted by printer 107. More specifically, finisher 108 can execute “sort output” in which a plurality of sheets of document are divided by the copy number to be outputted, “group output” in which a plurality of sheets of document are divided by the page, “staple processing” in which predetermined positions of a plurality of documents are stapled, “punch processing” in which punch holes are formed for filing are formed in predetermined positions of a plurality of documents.

Network interface 109 provides data intercommunication with another MFP, personal computer or the like through a network.

<Control Structure>

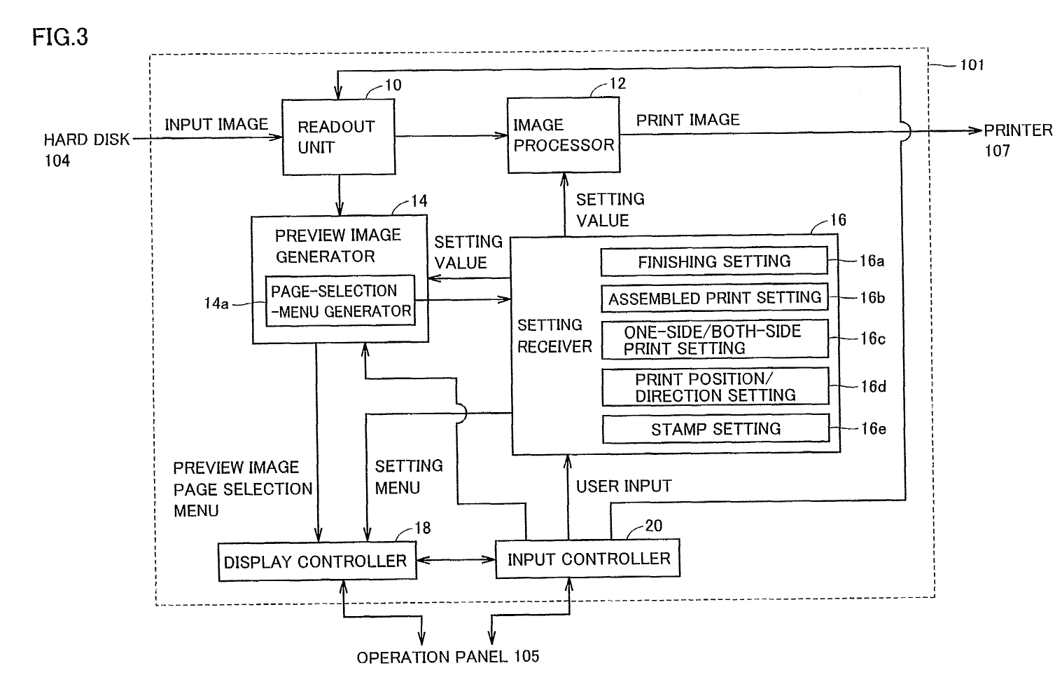

FIG. 3 is a block diagram showing a control structure in MFP 1 according to the embodiment.

Referring to FIG. 3, MFP 1 includes a readout unit 10, an image processor 12, a preview image generator 14, a setting receiver 16, a display controller 18, and an input controller 20 as the control structure thereof.

Readout unit 10 selectively reads out a specific input image from hard disk 104 or the like according to a user operation inputted through operation panel 105. The input image read out by readout unit 10 is outputted to preview image generator 14 and/or image processor 12.

Image processor 12 performs image processing for the input image according to setting values relating to the print output from setting receiver 16 described later to thereby generate a print image. This print image is outputted to printer 107 and is printed on paper.

Preview image generator 14 performs image processing for the input image according to the setting values relating to the print output from setting receiver 16 to thereby generate a preview image showing a print image when the input image is print-outputted according to the relevant setting values. This preview image is used to display an image to be printed to the user before the input image is print-outputted on actual paper.

Furthermore, preview image generator 14, in addition to the print image, includes a page-selection-menu generator 14a for displaying an area for selecting pages that have a specific attribute based on the contents of the setting relating to the printing in common, among the pages included in the print image. That is, page-selection-menu generator 14a, in addition to the print image, displays buttons each of which receives collective selection of one or more pages having the specific attribute among the pages included in the print image and the like. Details of this specific attribute based on the contents of setting relating to the printing will be described later.

Setting receiver 16 receives the setting relating to the print output of the input image, which is inputted through operation panel 105, and outputs the set contents (setting values) to image processor 12 and preview image generator 14. Setting receiver 16 displays a setting menu for the user to make the respective types of setting on operation panel 105. As representative examples of this setting relating to the print output, setting receiver 16 includes finishing setting 16a, assembled print setting 16b, one-side/both-side print setting 16c, print position/direction setting 16d, and stamp setting 16e These setting contents will be described later.

Display controller 18 causes the preview image and the page selection menu generated by preview image generator 14, the setting menu outputted from setting receiver 16 and the like to be displayed on operation panel 105. Input controller 20 outputs a corresponding command (user input) on the relevant menu screen to readout unit 10, preview image generator 14, setting receiver 16 and the like, when a specific area of a menu screen displayed on operation panel 105 is selected (pressed) by the user.

With correspondence relations between the configurations shown in FIGS. 1 and 3 and the present invention, setting receiver 16 corresponds to a “receiver”, and operation panel 105 corresponds to a “display”.

<Setting Contents Relating to Print Processing>

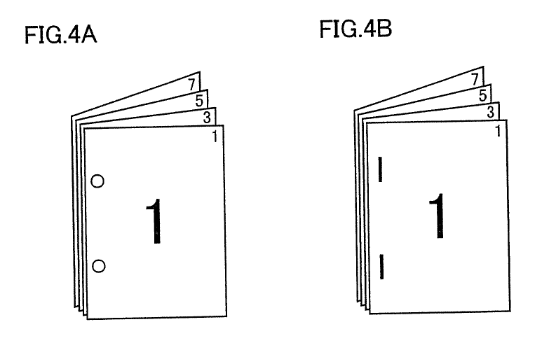

Next, referring to FIGS. 4A, 4B, 5A, 5B, 6, and 7, the setting contents relating to the print processing are described.

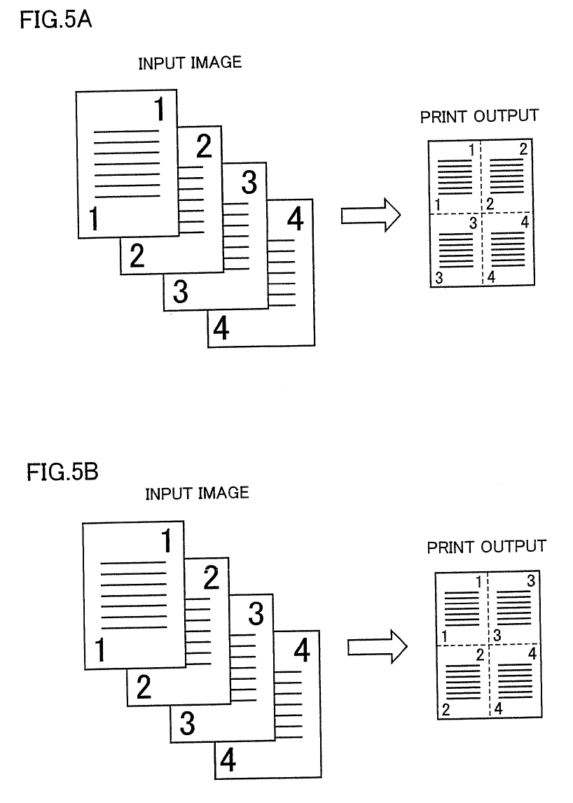

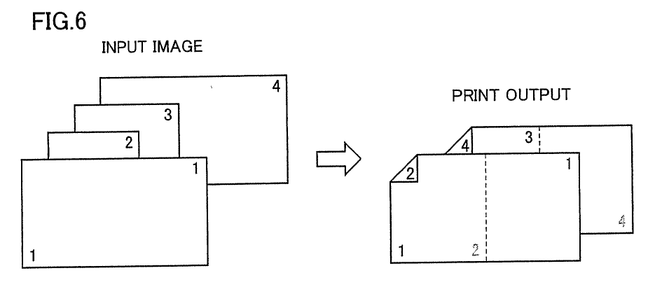

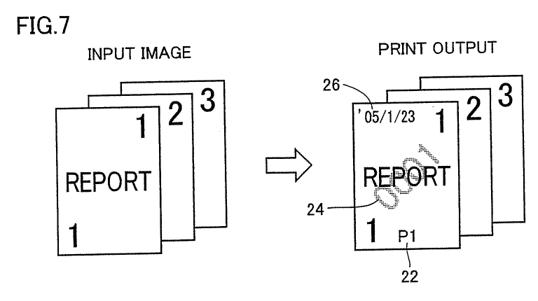

FIGS. 4A and 4B are diagrams for illustrating examples of finishing processing according to the embodiment. FIGS. 5A and 5B are diagrams for illustrating examples of assembled printing according to the embodiment. FIG. 6 is a diagram for illustrating one example of one-side/both-side print setting and print position/direction setting according to the embodiment. FIG. 7 is a diagram for illustrating one example of stamp processing according to the embodiment.

As one example of the finishing processing according to the embodiment, FIG. 4A shows punch processing in which punch holes for filing are formed in a predetermined position of a plurality of documents. Setting contents of this punch processing include the position where the punch holes are formed (e.g., at a right end, at a left end, at an upper end and the like), the number of the holes and the like. Moreover, as another example of the finishing processing according to the embodiment, FIG. 4B shows staple processing in which a plurality of documents are stapled in a predetermined position thereof Setting contents of the staple processing includes the position where stapling is performed (e.g., at a right upper end, at a right lateral end, at a left upper end, at a left lateral end and the like), the number of the positions and the like.

As one example of the assembled printing according to the embodiment, FIGS. 5A and 5B show processing when images of four pages included in the input image are print-outputted as an image of one page (so-called 4 in 1 output). Thus, the assembled printing is processing in which a plurality of pages included in the input image are assembled in one page to be print-outputted, and setting contents of this assembled printing includes the number of pages of the input image to be included in the print output of one page and the arrangement order of the respective pages of the input image.

As this arrangement order, a case of “lateral order” in which the respective pages included in the input image are assigned sequentially in a lateral direction is shown in FIG. 5A, while a case of “longitudinal order” in which the respective pages included in the input image are assigned sequentially in a longitudinal direction is shown in FIG. 5B.

FIG. 6 shows a case where the input image of four pages is printed on both sides of two sheets of paper. In the one-side/both-side print setting according to the embodiment, it is set whether the above-described respective pages of the input image are printed only on one side or on both sides.

Moreover, in FIG. 6, an example of the input image including two pages having a larger image size and two pages having a smaller image size is shown. Also, in the input image shown in FIG. 6, the two pages having the larger image size are arranged in a laterally long direction (landscape), while the two pages having the smaller image size are arranged in a longitudinally long direction (portrait). Thus, when the input image including the pages different from each other in image size and arrangement direction is printed on both sides at the same magnification, in paper corresponding to the pages having the smaller image size, blank space can be caused. Consequently, the setting contents of print position/direction setting according to the embodiment include the print position, print direction (closer to the right end, closer to the left end) and the like of the image to be print-outputted in the paper.

As one example of the stamp processing according to the embodiment, FIG. 7 shows processing when a page number 22, a watermark 24, and a print date 26 are synthesized in the input image to be print-outputted In this manner, in the stamp processing, after editing for adding some characters, signs and the like to the input image is performed, and the resultant image is print-outputted. The setting contents of this stamp processing include an item to be synthesized, a position of the item, and the like.

<Overall Processing Procedure>

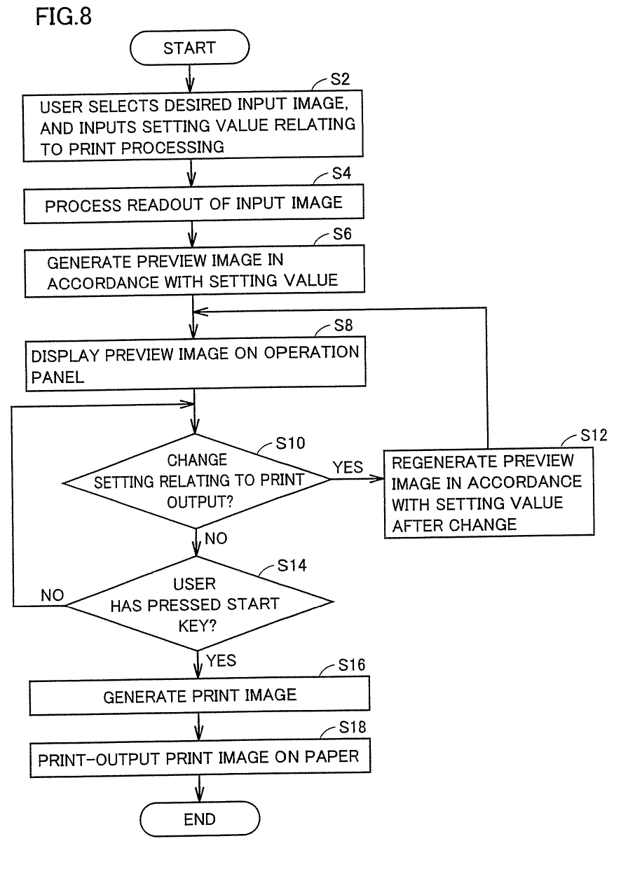

Next, referring to FIG. 8, an overall processing procedure in MFP 1 according to the embodiment is described. FIG. 8 is a flowchart showing overall processing in MFP 1 according to the embodiment.

Referring to FIGS. 1, 3 and 8, a user who wishes to perform some print output operates operation panel 105 to select a desired input image and input setting values relating to the print processing (step S2). These setting values inputted by the user are temporarily stored in setting receiver 16. The user presses start key 128 on operation panel 105, by which readout unit 10 executes readout processing of the input image (step S4). The readout processing of the input image by readout unit 10 includes input image generation from the document by image scanner 106, selection of the input image stored in advance in hard disk 104 or the like.

Subsequently, preview image generator 14 generates a preview image according to the setting values stored in setting receiver 16 (step S6), and further displays the generated preview image on operation panel 105 (step S8). At this time, page-selection-menu generator 14a displays a page selection menu for selecting pages having a specific attribute in common in addition to the preview image, as needed

Next, if the user changes any setting relating to the print output (in the case of YES in step S10), preview image generator 14 regenerates a preview image in accordance with setting values after changing (step S12) to display the regenerated preview image on operation panel 105 (step S8). The setting changed by the user is reflected on the setting values stored in setting receiver 16.

Meanwhile, if the user presses start key 128 on operation panel 105 again without changing the setting relating to the print output (in the case of YES in step S14), image processor 12 performs image processing for the input image according to the setting values stored in setting receiver 16 at the relevant point of time (the values after reflecting the change by the user) to thereby generate the print image (step S16). Furthermore, printer 107 print-outputs this print image on paper (step S118) The processing as one example has been completed.

In MFP 1 according to the embodiment, in addition to the preview image, the page selection menu for specifying pages having a specific attribute in common is displayed in a selectable manner, which allows setting change by the user to be easily performed

### PREVIEW SCREEN EXAMPLE 1

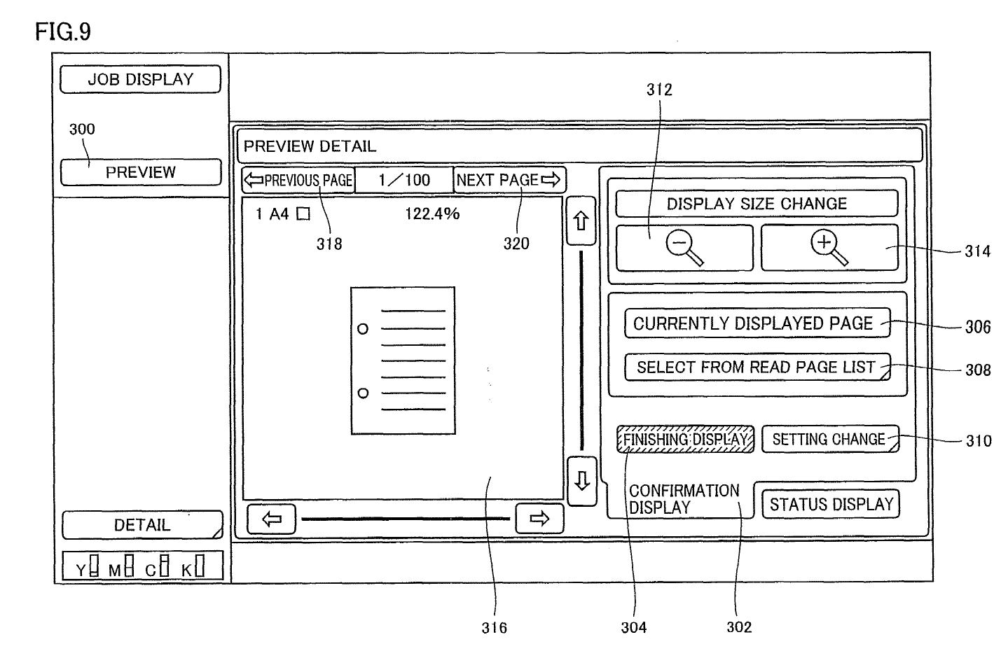

FIG. 9 is a diagram showing an example in a single-page display mode of the preview screen according to the embodiment. When a preview image is generated by preview image generator 14, display controller 18 causes the preview screen as shown in FIG. 9 to be displayed on operation panel 105 In this preview screen, when the user presses a preview button 300 among menu buttons displayed in a left end, a preview image is displayed in the single-page display mode as an initial mode. In this single-page display mode, one page of the preview image can be selected, and an image of the page being currently selected is displayed in an image display area 316.

When the user further presses a previous page button 318 or a next page button 320 in a confirmation display tab 302, display controller 18 updates the image displayed in image display area 316 to an image of a previous page or an image of a next page of the page being currently selected, respectively. Moreover, when the user presses a reduction button 312 or an enlargement button 314 in confirmation display tab 302, display controller 18 performs reduction display or enlargement display of the image displayed in image display area 316, respectively.

Moreover, a selection button 306 in confirmation display tab 302 is a button for selecting the single-page display mode, and a list selection button 308 is a button for selecting a list display mode. While an initial state of the preview screen is a state where selection button 306 is selected, when the user presses list selection button 308, display controller 18 changes the preview screen to the list display mode.

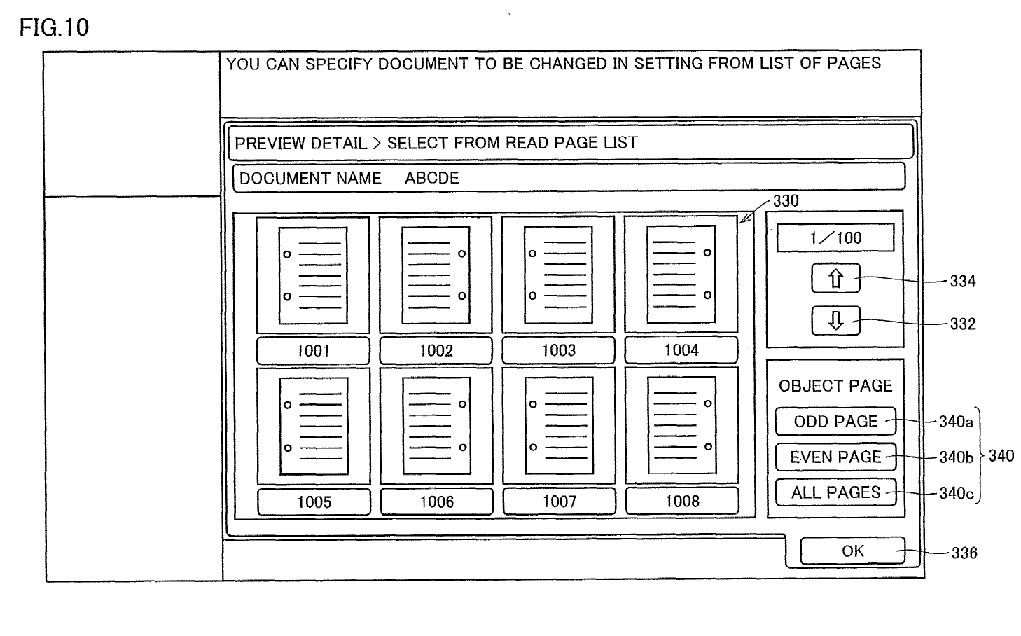

FIG. 10 is a diagram showing an example in the list display mode of the preview screen according to the embodiment (in case of both-side printing and finishing setting). If the list display mode is selected, display controller 18 causes a preview screen as shown in FIG. 10 to be displayed on operation panel 105. In the preview screen shown in FIG. 10, respective images of a plurality of pages included in the preview image are displayed in a list in image display area 330. Moreover, when the user presses a previous group button 332 or a next group button 334, display controller 18 updates images to be displayed in the list in image display area 330 to ones obtained by moving back or forward a group being currently selected by a predetermined number of pages.

Furthermore, display controller 18 displays a page selection menu 340 generated by page-selection-menu generator 14a for selecting pages having a specific attribute based on the contents of the setting relating to the printing in common. The preview screen shown in FIG. 10 is one example of the list display mode when both-side print setting is made, and in this case, as the specific attribute based on the contents of the setting relating to the printing, odd pages and even pages are displayed in a selectable manner among the pages included in the preview image.

That is, when the finishing setting such as the punch processing is made for the paper printed on both sides, for example, the punch holes are formed at the left end of the paper in the odd page, while the punch holes are formed on the opposite side (right end) in the even page. Therefore, if the print position with respect to the punch holes can be collectively set for odd pages, and also it can be collectively set for even pages, the user can make desired setting more quickly and more easily

Thus, “pages having a specific attribute based on the contents of setting in common” representatively means a group of pages on which it is preferable that when setting change relating to the printing is to be made, the relevant setting change is reflected collectively.

In the preview screen shown in FIG. 10, page selection menu 340 including an odd-page selection button 340a, an even-page selection button 340b, and an all-page selection button 340c is displayed. When the user presses odd-page selection button 340a, input controller 20 receives a selection command of odd pages by the user, and display controller 18 displays the odd pages in a selected state among the plurality of pages displayed in the list in image display area 330. As one example of the display of the selected state, display controller 18 may change a color of an outer frame of a page to be selected into a color different from that of an outer frame of a page to be unselected, and further, the color of the relevant outer frame may be blinked periodically Similarly, when the user presses even-page selection button 340b, input controller 20 receives a selection command of even pages by the user, and display controller 18 displays the even pages in a selected state among the plurality of pages displayed in the list in image display area 330.

Moreover, when the user presses all-page selection button 340, input controller 20 receives a selection command of all pages by the user, and display controller 18 displays all the pages displayed in the list in image display area 330 in a selected state. In the preview screen shown in FIG. 10, each of the pages displayed in the list in image display area 330 may be enabled to be selected individually.

Upon completing the selection of the pages to be changed in setting, the user presses an OK button 336. Display controller 18 returns the display on operation panel 105 to the preview screen of the single-page display mode shown in FIG. 9. Subsequently, when the user presses setting change button 310 shown in FIG. 9, display controller 18 displays a setting change screen on operation panel 105.

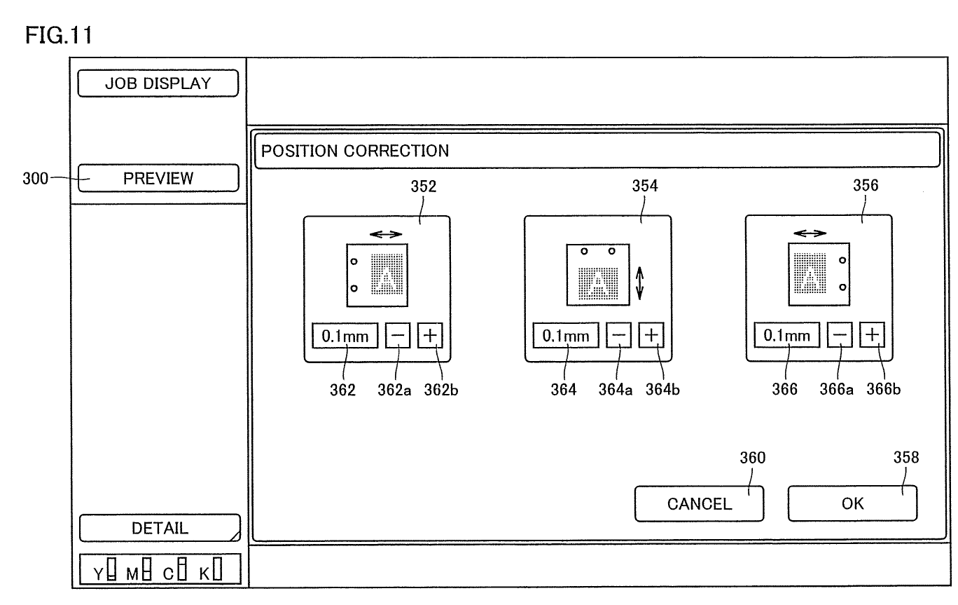

FIG. 11 is a diagram showing an example of the setting change screen according to the embodiment (in case of finishing setting). As described above, the user selects desired pages, and subsequently requests print setting, by which the setting change screen is displayed. The user makes setting change collectively for one or pages selected in advance by operating this setting change screen.

That is, display controller 18 performs display for changing the finishing setting as shown in FIG. 11 as one example of the setting change screen. In the setting change screen shown in FIG. 11, three types of setting menus 352, 354 and 356 are displayed based on formation positions of the punch holes. Among these, setting menu 352 is for a mode in which two punch holes are formed at the right end of paper, and the print position with respect to the punch holes can be changed to the left side or the right side of the paper. That is, input controller 20, in response to pressing of a −button 362a or a +button 362b by the user, sends out a command for decreasing or increasing the setting value by a predetermined amount to setting receiver 16 and display controller 18. Consequently, display controller 18 displays a value after the setting change inputted by the user operation in a setting value display area 362.

Similarly, setting menu 354 is for a mode in which two punch holes are formed at an upper end of the paper, and in response to pressing of a −button 364a or +button 364b by the user, a value after the setting change is displayed in a setting value display area 364. Moreover, setting menu 356 is for a mode in which two punch holes are formed at a right end of the paper, and in response to pressing of a −button 366a or +button 366b by the user, a value after the setting change is displayed in a setting value display area 366.

Upon completing the setting change, the user presses an OK button 358. Consequently, setting receiver 16 collectively reflects the setting contents inputted by the user operation described above on the pages selected in advance on the preview screen shown in FIG. 10. That is, setting receiver 16 updates the setting contents (of the pages selected in advance in the preview screen) stored in finishing setting 16a to the contents inputted by the user operation. Thereafter, display controller 18 returns the display on operation panel 105 to the preview screen of the single-page display mode shown in FIG. 9.

In contrast, when the user presses a cancel button 360, the setting contents inputted by the user operation are discarded, and the display on operation panel 105 returns to the preview screen of the single-page display mode shown in FIG. 9.

A series of operations by the user as described above allow the pages having a specific attribute in common to be selected, and the setting contents inputted subsequently after this selection are collectively reflected on the corresponding pages.

### PREVIEW SCREEN EXAMPLE 2

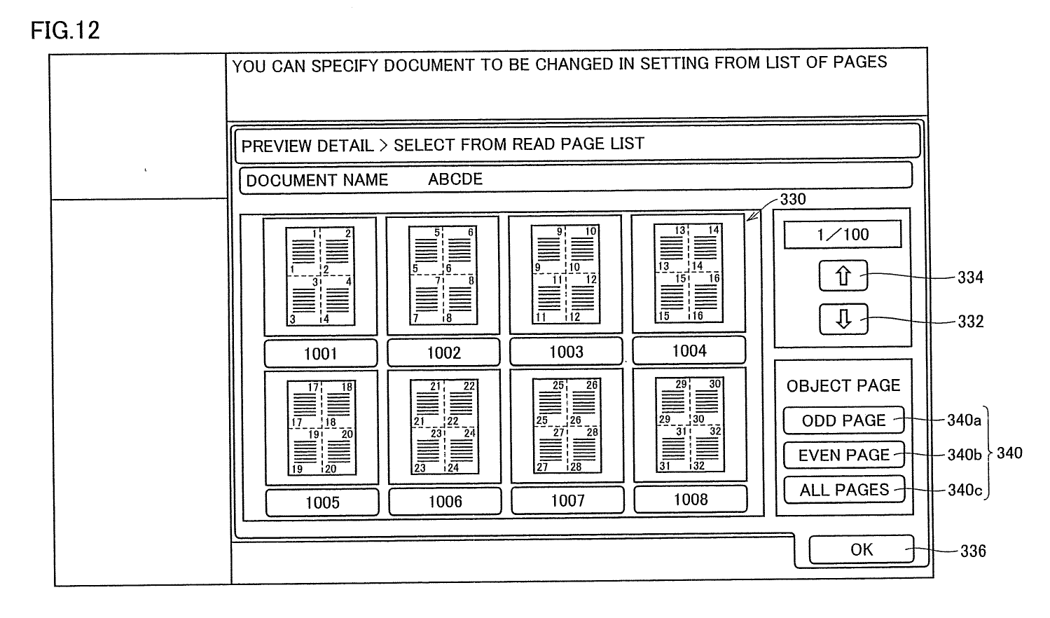

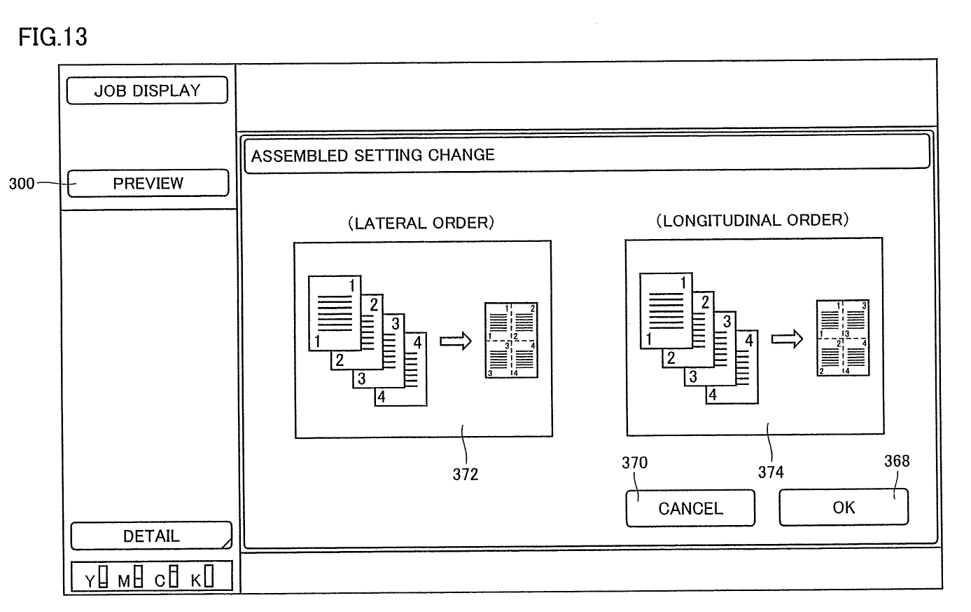

FIG. 12 is a diagram showing an example in the list display mode of the preview screen according to the embodiment (in case of assembled print setting). FIG. 13 is a diagram showing an example of the setting change screen according to the embodiment (in case of assembled print setting).

In the preview screen shown in FIG. 12, respective images of a plurality of pages included in the preview image are displayed in a list in image display area 330. Moreover, when the user presses previous group button 332 or next group button 340, display controller 18 updates images to be displayed in the list in image display area 330 to ones obtained by moving back or forward a group being currently selected by a predetermined number of pages.

Furthermore, display controller 18 displays page selection menu 340 generated by page-selection-menu generator 14a for selecting pages having a specific attribute based on the contents of setting relating to the printing in common. In the preview screen shown in FIG. 12, as the specific attribute based on the contents of setting relating to the printing, odd pages and even page are displayed in a selectable manner among the pages included in the preview image. That is, in this preview screen, page selection menu 340 including odd-page selection button 340a, even-page selection button 340b, and all-page selection button 340c is displayed.

Similar to the preview screen shown in FIG. 10, when the user presses odd-page selection button 340a, even-page selection button 340b, and all-page selection button 340c, respectively, display controller 18 receives commands for selecting odd pages, even pages and all pages, respectively, among a plurality of pages displayed in the list in image display area 330. Moreover, display controller 18 displays the selected pages in a selected state among the plurality of pages displayed in the list in image display area 330.

When the user presses OK button 336, display controller 18 returns the display on operation panel 105 to the preview screen of the single-page display mode shown in FIG. 9. Subsequently, when the user presses setting change button 310, display controller 18 displays a setting change screen shown in FIG. 13 on operation panel 105.

In the setting change screen shown in FIG. 13, for an assignment direction of the respective pages in the assembled printing, any one of “lateral order” and “longitudinally order” can be arbitrarily selected. That is, input controller 20, when the user presses a selection button 372, receives a command for changing the setting contents of the assembled printing to “lateral order”, and when the user presses a selection button 374, receives a command for changing the setting contents of the assembled printing to “longitudinal order”. Furthermore, when the user presses an OK button 368, setting receiver 16 collectively reflects the above-described setting contents inputted by the user operation on the pages selected in advance in the preview screen shown in FIG. 12. Thereafter, display controller 18 returns the display on operation panel 105 to the preview screen of the single-page display mode shown in FIG. 9

When the user presses a cancel button 370, the setting contents inputted by the user is discarded, and the display on operation panel 105 returns to the preview screen of the single-page display mode shown in FIG. 9.

### PREVIEW SCREEN EXAMPLE 3

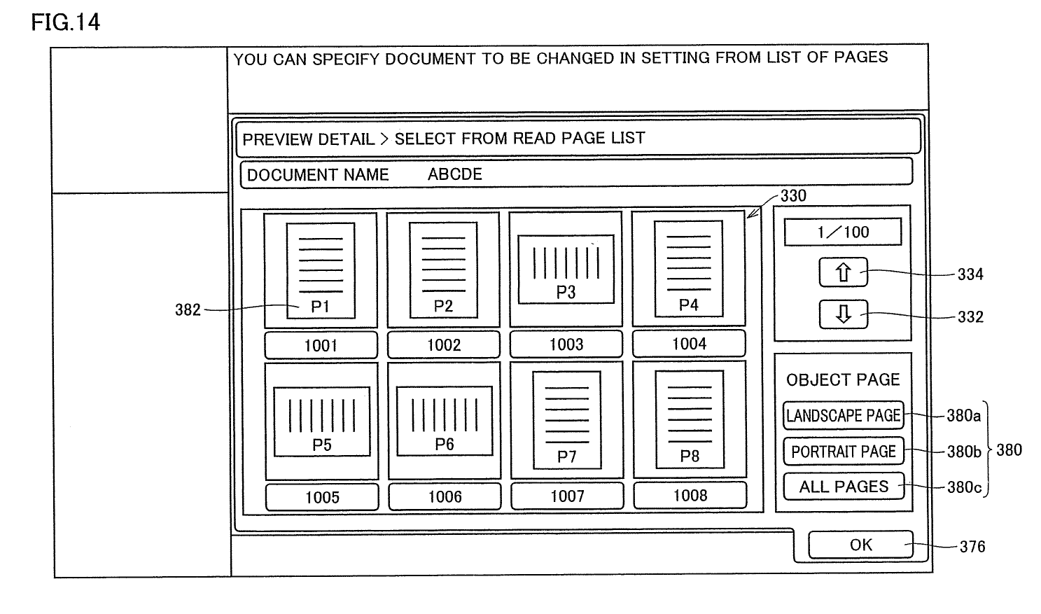

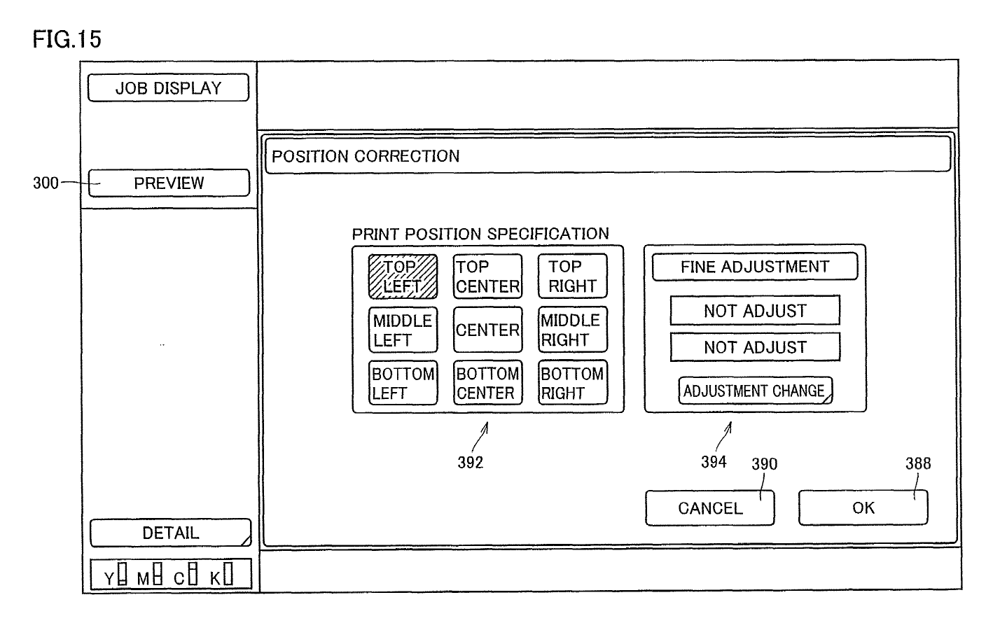

FIG. 14 is a diagram showing an example in the list display mode of the preview screen according to the embodiment (in the case where longitudinally long document(s) and laterally long document(s) are mixed and in case of stamp setting) FIG. 15 is a diagram showing an example of the setting change screen according to the embodiment (in the case where longitudinally long document(s) and laterally long document(s) are mixed and in case of stamp setting).

In the preview screen shown in FIG. 14, respective images of a plurality of pages included in the preview image are displayed in a list in image display area 330. Moreover, when the user presses previous group button 332 or next group button 334, display controller 18 updates images to be displayed in the list in image display area 330 to ones obtained by moving back or forward a group being currently selected by a predetermined number of pages.

Furthermore, display controller 18 displays a page selection menu 380 generated by page-selection-menu generator 14a for selecting pages having a specific attribute based on the setting contents relating to the printing in common. The preview screen shown in FIG. 14 is an example of the list display mode when the stamp processing of page numbers are set for the input image in which longitudinally long document(s) and laterally long document(s) are mixed. In this case, as the specific attribute based on the contents of the setting relating to the printing, a document direction (image direction) is displayed in a selectable manner.

That is, when the longitudinally long document(s) and the laterally long document(s) are mixed, setting can be made so as to add a page number in the center of a lower end of any page. Alternatively, setting can also be made such that the page number is added in the center on a short side in each of the pages, that is, for the longitudinally long document, the page number is added in the center of the lower end, while for the laterally long document, the page number is added in the center of the left end. Therefore, if these page positions and the like can be set collectively for the laterally long documents, and can also be set collectively for the longitudinally long documents, the user can perform desired more setting quickly and more easily.

In the preview screen shown in FIG. 14, page selection menu 380 including a landscape selection button 380a, a portrait selection button 380b, and an all-page selection button 380c is displayed.

When the user presses landscape selection button 380a, display controller 18 receives a command for selecting pages in the laterally long direction (landscape) among a plurality of pages displayed in a list in image display area 330. Moreover, when the user presses portrait selection button 380b, display controller 18 receives a command for selecting pages in the longitudinally long direction (portrait) among the plurality of pages displayed in the list in image display area 330. Also, display controller 18 displays the selected pages in a selected state among the plurality of pages displayed in the list in image display area 330.

Upon completing the selection of the pages to be changed in setting, the user presses an OK button 376. Consequently, display controller 18 returns the display on operation panel 105 to the preview screen of the single-page display mode shown in FIG. 9 Subsequently, when the user presses setting change button 310 shown in FIG. 9, display controller 18 displays a setting change screen shown in FIG. 15 on operation panel 105.

In the setting change screen shown in FIG. 15, a print position of a page number in each of the pages being selected can be arbitrarily specified. More specifically, a selection button group 392 for specifying a rough print position and an adjustment change button 394 for selecting a fine adjustment of the print position are displayed. Input controller 20, when the user presses any selection button of selection button group 392, receives a command for changing contents of the stamp processing (print position of the page number) to a corresponding position (e.g., “top left”, “bottom center” and the like). When the user presses adjustment change button 394, a setting screen for fine adjustment (not shown) is further displayed, and input controller 20 receives a command for finely adjusting the print position of the page number. Further, when the user presses an OK button 388, setting receiver 16 collectively reflects the setting contents inputted by the user operation described above on the pages selected in advance in the preview screen shown in FIG. 14. Thereafter, display controller 18 returns the display on operation panel 105 to the preview screen of the single-page display mode shown in FIG. 9.

When the user presses a cancel button 390, the setting contents inputted by the user operation is discarded, and the display on operation panel 105 returns to the preview screen of the single-page display mode shown in FIG. 9.

### PREVIEW SCREEN EXAMPLE 4

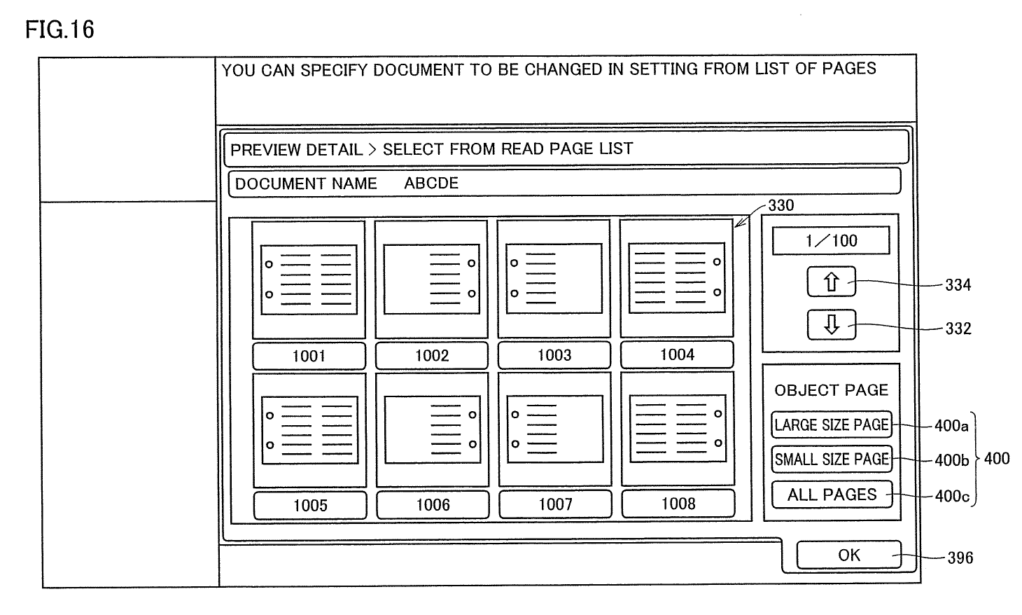

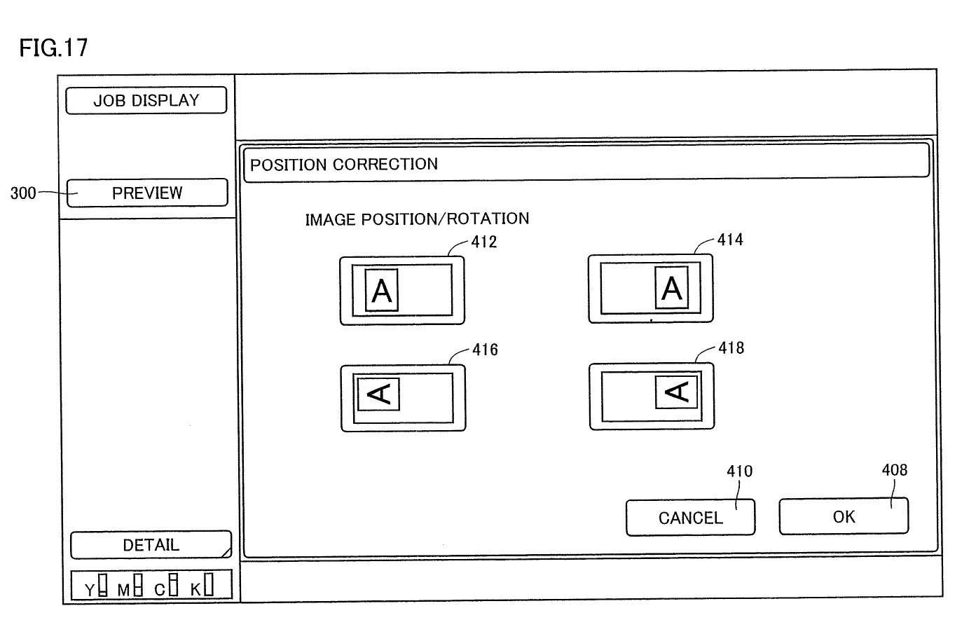

FIG. 16 is a diagram showing an example in the list display mode of the preview screen according to the embodiment (in the case where a plurality of image sizes are mixed, and in case of both-side print setting). FIG. 17 is a diagram showing an example of the setting change screen according to the embodiment (in the case where a plurality of image sizes are mixed, and in case of both-side print setting).

In the preview screen shown in FIG. 16, respective images of a plurality of pages included in a preview image are displayed in a list in image display area 330. Moreover, when the user presses previous group button 332 or next group button 334, display controller 18 updates images to be displayed in the list in image display area 330 to ones obtained by moving back or forward a group being currently selected by a predetermined number of pages.

Furthermore, display controller 18 displays a page selection menu 400 generated by page-selection-menu generator 14a for selecting pages having a specific attribute based on the contents of the setting relating to the printing in common. The preview screen shown in FIG. 16 is one example of the list display mode when both-side print setting is made for the input image in which a plurality of image sizes are mixed. In this case, as the specific attribute based on the contents of the setting relating to the printing, print directions (image directions) and print positions (image positions) are displayed in a selectable manner.

That is, when both-side printing is set in the case where a plurality of image sizes are mixed, the size of paper is determined so that the largest image size can be printed, and thus, when a smaller image size is printed on paper of the same size, blank space can be caused on the paper. In other words, this means that when a page of the smaller image size is printed, the print direction and the print position on the paper can be set with higher degrees of freedom. Therefore, if the above-described print direction, print position and the like can be collectively set for the pages having the same image size, the user can perform desired setting more quickly and more easily.

In the preview screen shown in FIG. 16, page selection menu 400 including a large-size selection button 400a, a small-size selection button 400b, and an all-page selection button 400c is displayed. While page selection menu 400 shown in FIG. 16 shows a case where two types of image sizes are mixed in the input image, in a case where more types of image sizes are mixed, selection buttons in accordance with the number of types of image sizes will be displayed.

When the user presses large-size selection button 400a, display controller 18 receives a command for selecting pages having the larger image size among a plurality of pages displayed in a list in image display area 330. Moreover, when the user presses small-size selection button 400b, display controller 18 receives a command for selecting pages having the smaller image size among the plurality of pages displayed in the list in image display area 330. Also, display controller 18 displays the selected pages in a selected state among the plurality of pages displayed in the list in image display area 330.

Upon completing the selection of the pages to be changed in setting, the user presses an OK button 396. Display controller 18 returns the display in operation panel 105 to the preview screen of the single-page display mode shown in FIG. 9. Subsequently, when the user presses setting change button 310 shown in FIG. 9, display controller 18 displays a setting change screen shown in FIG. 17 on operation panel 105.

In the setting change screen shown in FIG. 17, a combination of a print direction and a print position of an image in the paper in the pages being selected can be arbitrarily specified. As an example, a selection button 412 for arranging the image in a longitudinally long direction with respect to the paper left end, a selection button 414 for arranging the image in the longitudinally long direction with respect to the paper right end, a selection button 416 for arranging the image in a laterally long direction with respect to the paper left upper end, and a selection button 418 for arranging the image in the laterally long direction with respect to the paper right upper end are displayed. Input controller 20, when the user presses any one of selection buttons 412 to 418, receives a command for changing a setting value of the print direction and the print position to the contents corresponding to the relevant button. Furthermore, when the user presses an OK button 408, setting receiver 16 collectively reflects the setting contents inputted by the user operation on the pages selected in advance in the preview screen shown in FIG. 16. Thereafter, display controller 18 returns the display on operation panel 105 to the preview screen of the single-page display mode shown in FIG. 9.

When the user presses a cancel button 410, the setting contents inputted by the user is discarded, and the display on operation panel 105 returns to the preview screen of the single-page display mode shown in FIG. 9.

### PREVIEW SCREEN EXAMPLE 5

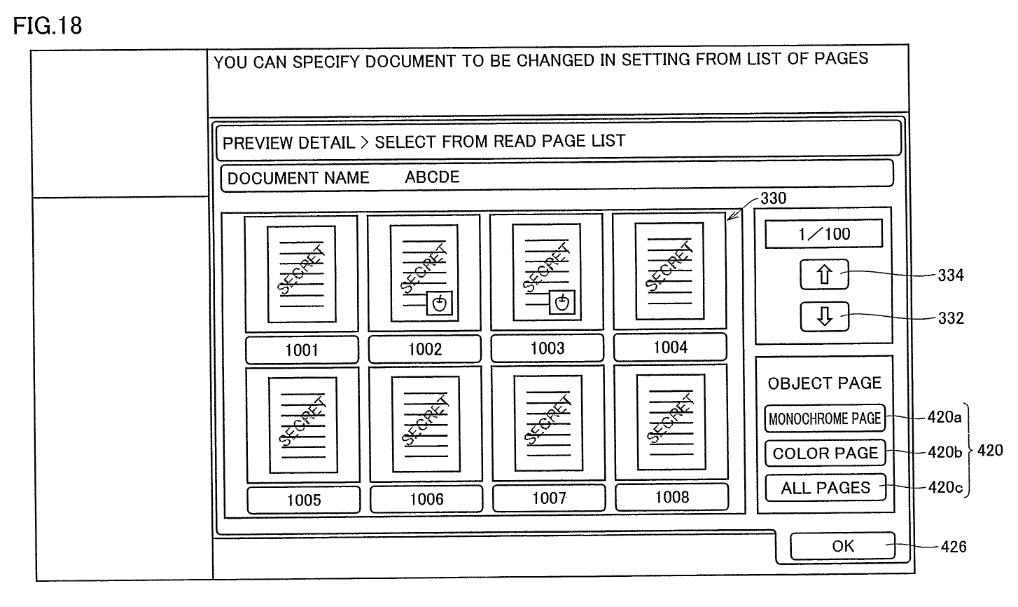

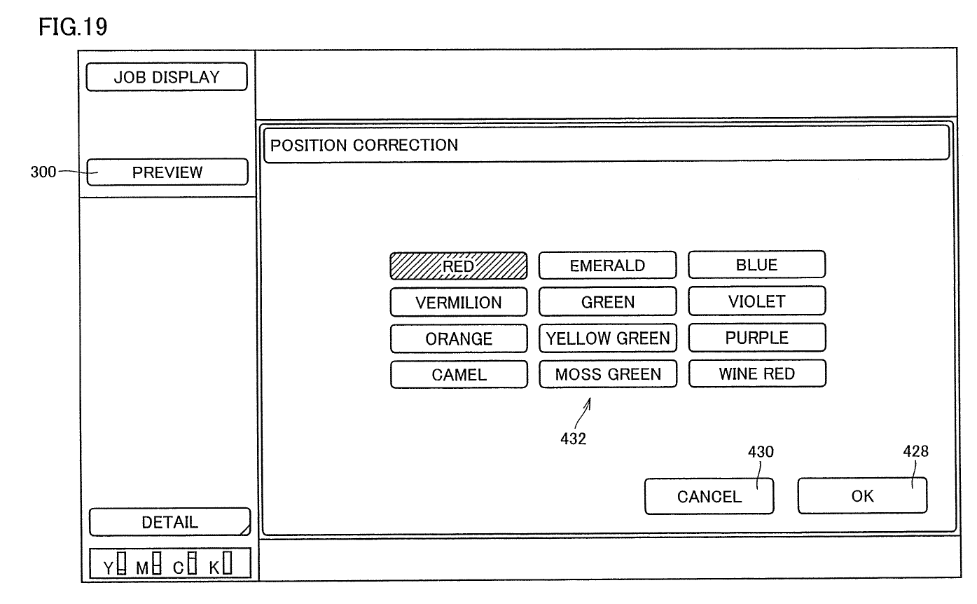

FIG. 18 is a diagram showing an example in the list display mode of the preview screen according to the embodiment (in the case where monochrome images and color images are mixed, and in case of stamp setting). FIG. 19 is a diagram showing an example of the setting change screen according to the embodiment (in the case where monochrome images and color images are mixed, and in case of stamp setting).

In the preview screen shown in FIG. 18, respective images of a plurality of pages included in the preview image are displayed in a list in image display area 330. Moreover, when the user presses previous group button 332 or next group button 334, display controller 18 updates images to be displayed in the list in image display area 330 to ones obtained by moving back or forward a group being currently selected by a predetermined number of pages.

Furthermore, display controller 18 displays a page selection menu 420 generated by page-selection-menu generator 14a for selecting pages having a specific attribute based on the contents of the setting relating to the printing in common. The preview screen shown in FIG. 18 is an example of the list display mode when stamp setting for synthesizing characters of “SECRET” is made for the input image in which the monochrome images and the color images are mixed. In this case, as the specific attribute based on the contents of setting relating to the printing, the monochrome images and the color images are displayed in a selectable manner.

More specifically, when the stamp setting is made for a color image, a relative relationship between a background color of the relevant color image and a synthesized font color may decrease visibility of the characters to be synthesized. For example, it is preferable to synthesize characters of a light color for a color image whose background color is a deep color. Meanwhile, if the above-described stamp setting is applied to a monochrome image as it is, since a background of the monochrome image is generally white, in some case, sufficient visibility cannot be exerted Accordingly, it may be preferable that a color of characters to be synthesized for a monochrome image, and a color of characters to be synthesized for a color image are appropriately set, respectively. Consequently, if the stamp setting can be collectively made for pages of monochrome images and pages of color images, respectively, the user can make desired setting more quickly and more easily.

In the preview screen shown in FIG. 18, page selection menu 420 including a monochrome-page selection button 420a, a color-page selection button 420b, and an all-page selection button 420c is displayed.

When the user presses monochrome-page selection button 420a, display controller 18 receives a command for selecting pages of monochrome images among a plurality of pages displayed in a list in image display area 330. Moreover, when the user presses color-page selection button 420b, display controller 18 receives a command for selecting pages of color images among the plurality of pages displayed in the list in image display area 330. Also, display controller 18 displays the selected pages in a selected state among the plurality of pages displayed in the list in image display area 330.

Upon completing the selection of the pages to be changed in setting, the user presses an OK button 426. Display controller 18 returns the display on operation panel 105 to the preview screen of the single-page display mode shown in FIG. 9. Subsequently, when the user presses setting change button 310 shown in FIG. 9, display controller 18 displays the setting change screen shown in FIG. 19 on operation panel 105.

In the setting screen shown in FIG. 19, as one example, a color of the characters to be synthesized can be arbitrarily specified. More specifically, a selection button group 432 for specifying a font color is displayed. Input controller 20, when the user presses any of selection buttons of selection button group 432, receives a command for changing a setting value of the font color to be synthesized in the stamp setting to a color corresponding to the relevant button. Furthermore, when the user presses an OK button 428, setting receiver 16 collectively reflects the setting contents inputted by the user operation on the pages selected in advance in the preview screen shown in FIG. 18. Thereafter, display controller 18 returns the display on operation panel 105 to the preview screen of the single-page display mode shown in FIG. 9.

When the user presses a cancel button 430, the setting contents inputted by the user is discarded, and the display on operation panel 105 returns to the preview screen of the single-page display mode shown in FIG. 9.

### PREVIEW SCREEN EXAMPLE 6

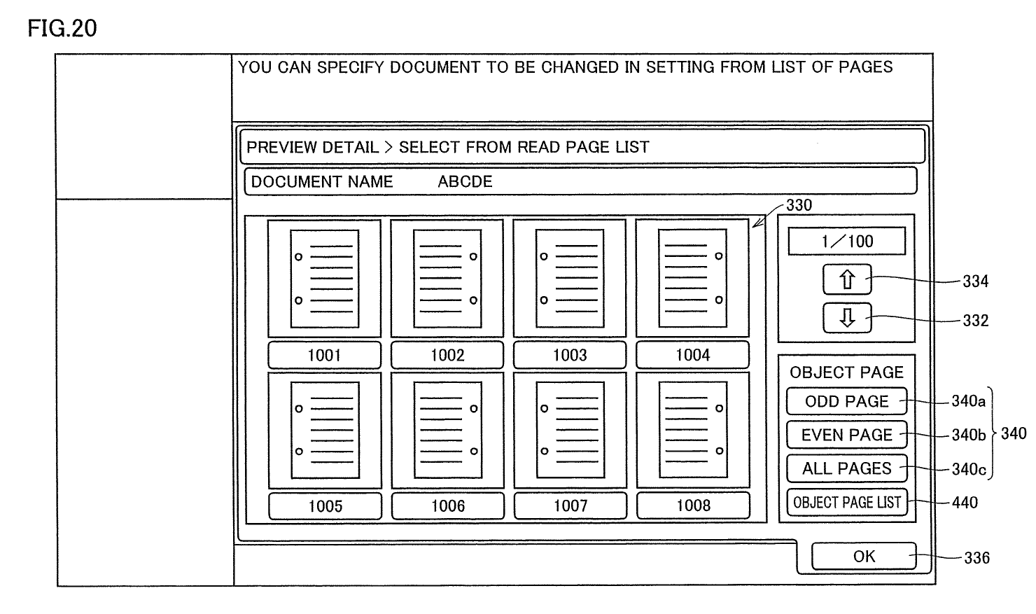

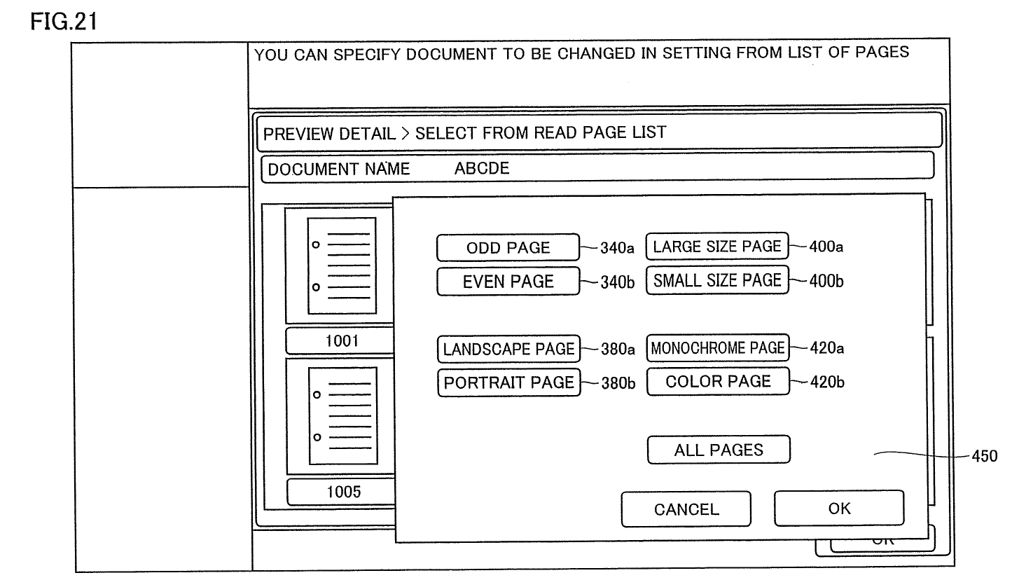

While in the above-described preview screen examples 1 to 5, for easy understanding, the cases of setting relating to the individual print output are exemplified, a plurality of items may be simultaneously set for the same input image. In this case, a plurality of selection candidates of pages having specific attributes based on the contents of setting relating to the printing in common exist, and it is desirable that these can be selected more easily. Consequently, referring to FIGS. 20 and 21, a screen example when a plurality of selection candidates exist is described.

FIG. 20 is a diagram showing an example in the list display mode of the preview screen according to the embodiment (in case of setting a plurality of items). FIG. 21 is a diagram showing an example of a submenu 450 in the preview screen shown in FIG. 20.

In the preview screen shown in FIG. 20, an object-page list button 440 is added to the preview screen shown in FIG. 10. When a plurality of items are included in the setting relating to the current printing, page-selection-menu generator 14a generates submenu 450 from which the setting of pages having specific attributes in common can be selected. When the user presses object-page list button 440, display controller 18 displays submenu 450 generated by page-selection-menu generator 14a so as to be overlapped on the preview screen, as shown in FIG. 21.

Submenu 450 shown in FIG. 21, buttons for selecting selectable page candidates are displayed in a list in response to the setting relating to the printing. While in the example shown in FIG. 21, a case where all of the above-described selection buttons are selectable is shown, only necessary selection buttons based on the setting items may be displayed in this submenu 450.

In this submenu 450, when the user presses any ones of the selection buttons, display controller 18 receives a command for selecting pages corresponding to the pressed buttons. Setting receiver 16 collectively reflects the setting contents inputted by the user operation similar to the foregoing on the selected pages.

<Processing Procedure>

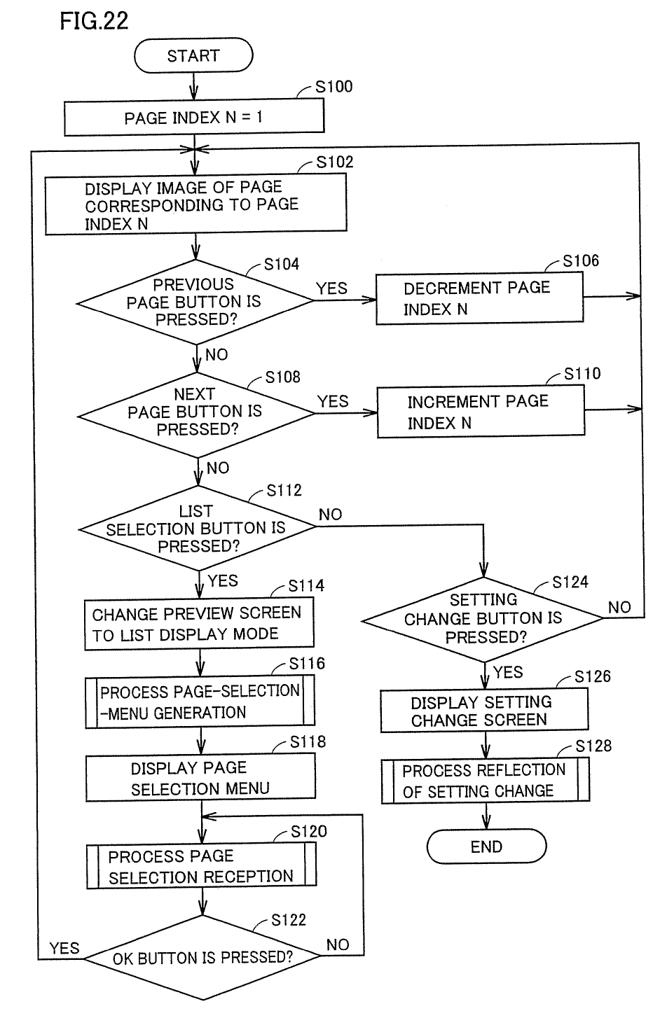

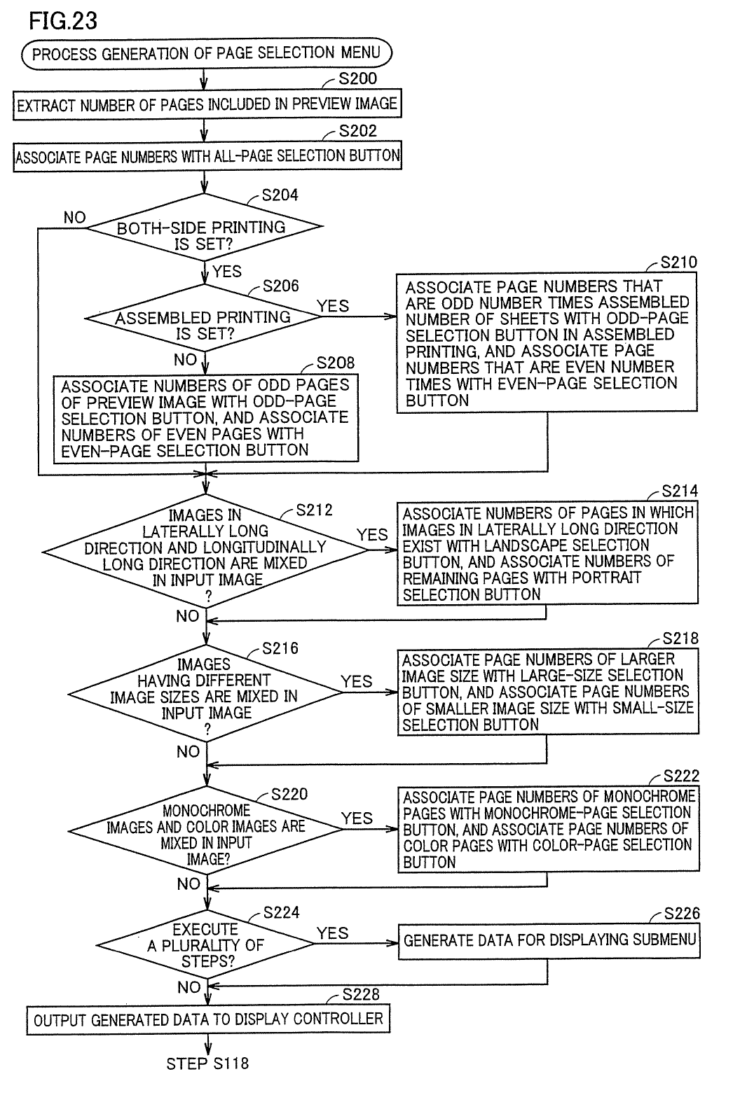

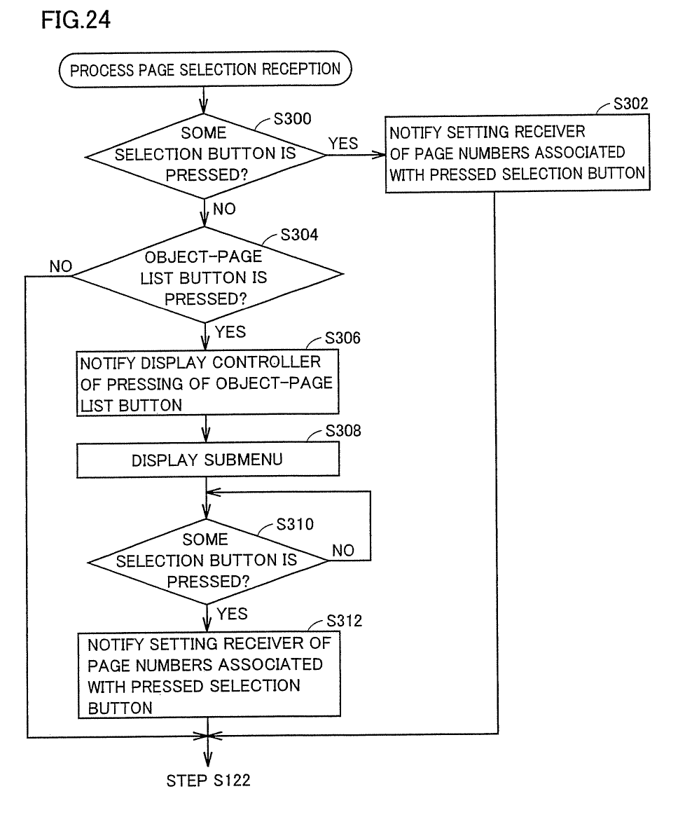

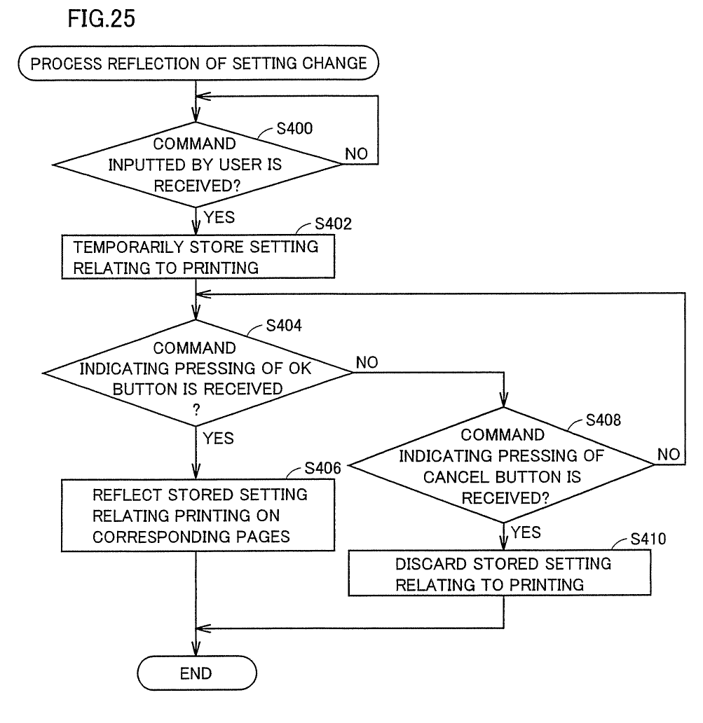

FIG. 22 is a flowchart showing more detailed processing contents in the preview display processing in step S8 shown in FIG. 8. FIG. 23 is a flowchart showing more detailed contents of page-selection-menu generating processing in step S116 in FIG. 22. FIG. 24 is a flowchart showing more detailed contents of page selection receiving processing in step S120 in FIG. 22. FIG. 25 is a flowchart showing more detailed contents of reflection processing of setting change in step S128 in FIG. 22. The series of processing in the flowcharts shown in FIGS. 22 to 25 are representatively provided by a control structure of MFP 1 shown in FIG. 3.

Referring to FIG. 22, display controller 18 first initiates a page index N to 1 (step S100), and displays an image of a page corresponding to page index N in the preview image generated by preview image generator 14 on operation panel 105 (step S102).

Subsequently, input controller 20 determines whether or not previous page button 318 is pressed (step S104). If previous page button 318 is pressed (in the case of YES in Step S104), display controller 18 decrements page index N by 1 (step S106), and displays an image of a page corresponding to page index N after the decrement in the preview image on operation panel 105 (step S102).

If previous page button 318 is not pressed (in the case of NO in step S104), input controller 20 determines whether or not next page button 320 is pressed (step S108). If next page button 320 is pressed (in the case of YES in step S108), display controller 18 increments page index N by 1 (step S110), and displays an image of a page corresponding to page index N after the increment in the preview image on operation panel 105 (step S102).

If next page button 320 is not pressed (in the case of NO in step S108), input controller 20 determines whether or not list selection button 308 is pressed (step S12). If list selection button 308 is pressed (in the case of YES in step S112), display controller 18 changes the preview screen displayed on operation panel 105 to the list display mode (step S114). Subsequently, page-selection-menu generator 14a generates data for displaying page selection menu 340 based on the preview image (step S116), and display controller 18 displays page selection menu 340 in accordance with this data (step S118). Furthermore, input controller 20 executes reception processing of the operation of page selection menu 340 by the user (step S120), and then determines whether or not OK button 336 is pressed (step S122). If OK button 336 is not pressed (in the case of NO in step S122), processing in step S120 and later is repeated. In contrast, if OK button 336 is pressed (in the case of YES in step S122), the processing is returned to step S102.

If list selection button 308 is not pressed (in the case of NO in step S112), input controller 20 determines whether or not setting change button 310 is pressed (step S124). If setting change button 310 is pressed (in the case of YES in step S124), display controller 18 displays the setting change screen on operation panel 105 (step S126). Setting receiver 16 receives the operation to the setting change screen by the user, and collectively reflects the setting contents in accordance with this user operation on one or more pages selected in advance (step S128). Then, the preview display processing ends.

If setting change button 310 is not pressed (in the case of NO in step S124), the processing is returned to step S102.

Referring to FIG. 23, page-selection-menu generator 14a extracts the number of pages including in the preview image (step S200), and page numbers thereof are associated with all-page selection button 340c (380c, 400c, 420c) (step S202).

Subsequently, referring to finishing setting 16a of setting receiver 16, page-selection-menu generator 14a determines whether or not the both-side printing is set (step S204). If the both-side printing is set (in the case of YES in step S204), referring to assembled print setting 16b of setting receiver 16, page-selection-menu generator 14a determines whether or not the assembled printing is set (step S206).

If the assembled printing is not set (in the case of NO in step S206), page-selection-menu generator 14a associates numbers of odd pages among the pages included in the preview image with odd-page selection button 340a, and associates numbers of even pages with even-page selection button 340b (step S208).

If the assembled printing is set (in the case of YES in step S206), page-selection-menu generator 14a extracts the number of pages included in the input image, and associates, with odd-page selection button 340a, page members that are odd number times an assembled number of sheets N of the assembled printing (N, 3N, . . . ) among the above-mentioned member of pages, and associates, with even-page selection button 340b, page numbers that are even number times the assembled number of sheets N of the assembled printing (2N, 4N, . . . ) (step S210).

Furthermore, page-selection-menu generator 14a determines whether or not images in the laterally long direction (landscape) and images in the longitudinally long direction (portrait) are mixed in the input image (step S212). If the images in the laterally long direction and in the longitudinally long direction are mixed in the input image (in the case of YES in step S212), pages where the images in the laterally long direction exist in the input image are extracted to associate page numbers thereof with landscape selection button 380a, and associate the remaining page numbers with portrait selection button 380b (step S214).

Furthermore, page-selection-menu generator 14a determines whether or not images having different image sizes are mixed in the input image (step S216). If images having different image sizes are mixed in the input image (in the case of YES in step S216), pages of a larger image size are extracted among the input image to associate page numbers thereof with large-size selection button 400a, and pages of a smaller image size are extracted to associate page numbers thereof with small-size selection button 400b (step S218).

Furthermore, page-selection-menu generator 14a determines whether or not monochrome images and color images are mixed in the input image (step S220). If monochrome images and color images are mixed in the input image (in the case of YES in step S220), the monochrome pages are extracted from the input image to associate page numbers thereof with monochrome-page selection button 420a, and color pages are extracted to associate page numbers thereof with color-page selection button 420b (step S222).

Furthermore, page-selection-menu generator 14a determines whether or not a plurality of steps are executed among steps S208, S210, S214, S218, and S222 (S224). That is, page-selection-menu generator 14a determines whether or not a plurality of print setting items are simultaneously set as the print setting. If the plurality of steps are executed among the above-described steps (in the case of YES in step S224), page-selection-menu generator 14a generates data for displaying submenu 450 including the list of the associated selection buttons in executed steps (step S226).

Finally, page-selection-menu generator 14a outputs the data associated by the above-described processing and the like to display controller 18 (step S228). Thereafter, processing in step S118 in FIG. 22 is executed.

Referring to FIG. 24, input controller 20 determines whether or not any of the selection buttons making up page selection menu 340 (380, 400, 420) being displayed is pressed (step S300). If any of the selection buttons is pressed (in the case of YES in step S300), input controller 20, referring to the data generated by page-selection-menu generator 14a, notifies setting receiver 16 of the page numbers associated with the pressed selection button (step S302).

Meanwhile, if none of the selection buttons is pressed (in the case of NO in step S300), input controller 20 determines whether or not object-page list button 440 is pressed (step S304). If object-page list button 440 is pressed (YES in step S304), input controller 20 notifies display controller 18 of the pressing of object page list button 440 (step S306). Consequently, display controller 18 displays submenu 450 based on the data from page-selection-menu generator 14a (step S308). Subsequently, input controller 20 determines whether or not any of the selection buttons included in submenu 450 (step S310) is pressed. If any of the selection button is pressed (in the case of YES in step S310), input controller 20, referring to the data generated by page-selection-menu generator 14a, notifies setting receiver 16 of the page numbers associated with the pressed selection button (step S312)

Meanwhile, if none of the selection buttons is pressed (in the case of NO in step S3 10), the processing in step S310 is repeated.

After executing the above-described processing, the processing of step 122 in FIG. 22 is executed.

Referring to FIG. 25, setting receiver 16 waits for the reception of a command that the user has inputted to the setting change screen through input controller 20 (step S400). Upon receiving the command inputted by the user (in the case of YES in step S400), setting receiver 16 temporarily stores the setting relating to the printing in accordance with the relevant command (step S402).

Furthermore, setting receiver 16 determines whether or not a command indicating the pressing of the OK button in the setting change screen through input controller 20 is received (step S404). If the command indicating the pressing of the OK button is received (in the case of YES in step S404), setting receiver 16 reflects the setting relating to the printing stored in step S402 on the corresponding pages, based on the page numbers received in advance from input controller 20 in S3 12 of FIG. 24 (step S406) More specifically, setting receiver 16 collectively updates the contents of the corresponding setting in the corresponding pages among finishing setting 16a, assembled print setting 16b, one-side/both-side print setting 16c, print position/direction setting 16d, and stamp setting 16e.

Meanwhile, if the command indicating the pressing of the OK button (in the case of NO in step S404) is not received, setting receiver 16 determines whether or not a command indicating the pressing of the cancel button in the setting change screen through input controller 20 is received (step S408). If the command indicating the pressing of the cancel button is received (in the case of YES in step S408), setting receiver 16 discards the setting relating to the printing, which has been temporarily stored in step S402 (step S410).

Moreover, if the command indicating the pressing of the cancel button is not received (in the case of NO in step S408), the processing in step S404 and later is repeated.

When the above-described processing ends, the preview display processing ends.

### Effects of Embodiment

According to the embodiment of the present invention, pages having a specific attribute in common can be collectively selected based on the contents of setting relating to print output at the time of preview display before print output. When the user sets the desired contents subsequently after this page selection, the relevant contents are collectively reflected on the selected pages. Therefore, even when a plurality of types of page setting are included in the pages to be print-outputted, the setting contents of the respective pages can be changed easily and quickly. As a result, a more user-friendly image processing apparatus can be provided.

### Other Embodiments

While in the above-described embodiment, a constitution in which the image processing apparatus according to the present invention is implemented by an MFP is exemplified, it may be implemented by using a personal computer executing a document creating application or the like. In this case, the document creating application generates an input image to be print-outputted.

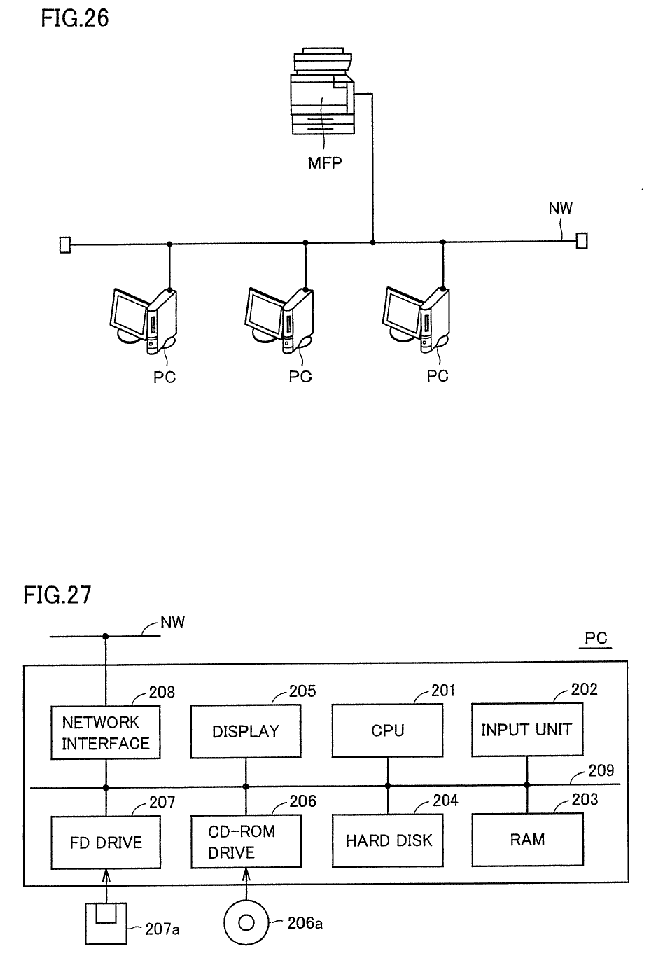

FIG. 26 is a schematic configuration diagram of a system according to another embodiment of the present invention.

Referring to FIG. 26, in the system according to the embodiment, a personal computer PC serving as the image processing apparatus according to the present invention and an MFP capable of print-outputting an input image are configured so as to intercommunicate data through a network NW.

In personal computer PC, representatively, a known operating system (OS) is installed, and by executing a program that executes the image processing method according to the present invention on the relevant operating system, personal computer PC serves as the image processing apparatus according to the present invention.

FIG. 27 is a schematic diagram showing a schematic hardware configuration of personal computer PC according to the other embodiment of the present invention.

Referring to FIG. 27, personal computer PC includes a CPU 210 that executes the operating system, the program according to the present invention and the like, a RAM (Random Access Memory) 203 that temporarily stores data necessary for the processing in CPU 201, and a hard disk 204 that stores the operating system and the program executed in CPU 201 in a nonvolatile manner. The program according to the present invention is read from a CD-ROM (Compact Disk-Read Only Memory) 206a, a flexible disk 207a or the like, by a CD-ROM drive 206 or a flexible disk (FD) drive 207, respectively.

CPU 201 receives an operation request by the user through an input unit 202 made up of a keyboard, a mouse and the like, and outputs image output generated by the execution of the program to a display 205. Moreover, CPU 201 intercommunicates data with MFP 1 through a network interface 208 made up of a LAN card or the like. The respective units are connected to one another through an internal bus 209.

The use of the above-described hardware allows a function similar to the above-described function provided by MFP 1 to be provided using personal computer PC. The contents of the provided function are similar to the foregoing, and thus a detailed description is not repeated.

Furthermore, the program according to the present invention may also read out and execute a necessary module in a predetermined sequence and at predetermined timing among program modules provided as a part of the operating system. In this case, the above-described modules may not included in the program itself, but the processing may be executed in cooperation with the operating system. The program not including the above-described modules can also be included by the program according to the present invention.

The program according to the present invention may also be provided by being incorporated in a part of another program. Also, in this case, the modules included in the above-described another program is not included in the program itself, but the processing is executed in cooperation with the other program. The above-described program incorporated in the other program can also be included by the program according to the present invention.

A provided program product is installed in a program storage such as a hard disk to be executed. The program product includes the program itself, and a storage medium in which the program is stored.

Furthermore, some or all of the functions implemented by the program according to the present invention may be configured by dedicated hardware.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image processing apparatus comprising:
a receiver for receiving setting relating to print output; and
a display for displaying a print image when an input image is print-outputted in accordance with said setting; wherein
said display displays, in addition to said print image, an area for selecting pages having a specific attribute based on a content of said setting in common, among the pages included in said print image, and
said receiver, when a user operates said area, reflects setting inputted subsequently after the operation of the relevant area on the corresponding pages.

2. The image processing apparatus according to claim 1, wherein said display provides a print image in accordance with the setting inputted subsequently after the selection in said area.

3. The image processing apparatus according to claim 1, wherein said setting includes finishing setting for print-outputted paper.

4. The image processing apparatus according to claim 1, wherein said setting includes setting for assembling a plurality of pages included in said input image in a single page to print-out the same.

5. The image processing apparatus according to claim 1, wherein said area displayed in said display includes an area in which an odd page and an even page can be selected respectively among the pages included in said print image.

6. The image processing apparatus according to claim 1, wherein when said input image includes a plurality of pages having different sizes, said area displayed in said display includes an area in which the page included in said print image can be selected by the image size.

7. The image processing apparatus according to claim 1, wherein when said input image includes a plurality of pages having different image directions, said area displayed in said display includes an area in which the page included in said print image can be selected by the image direction.

8. The image processing apparatus according to claim 1, wherein when said input image includes a color image and a monochrome image, said area displayed in said display includes an area in which the color image and the monochrome image can be selected respectively among the pages included in said print image.

9. An image processing method comprising the steps of
receiving setting relating to print output, and
displaying a print image when an input image is print-outputted in accordance with said setting, in a display, wherein
said step of displaying includes the step of displaying an area for selecting pages having a specific attribute based on a content of said setting in common among pages included in said print image, in addition to said print image, and
said step of receiving includes the step of reflecting, in response to user operation of said area, setting inputted subsequently after the operation of the relevant area on the corresponding pages.

10. The image processing method according to claim 9, wherein said step of displaying further includes the step of redisplaying a print image in accordance with the setting inputted subsequently after the selection in said area.

11. The image processing method according to claim 9, wherein said setting includes finishing setting for print-outputted paper.

12. The image processing method according to claim 9, wherein said setting includes setting for assembling a plurality of pages included in said input image in a single page to print-out the same.

13. The image processing method according to claim 9, wherein said displayed area includes an area in which an odd page and an even page can be selected respectively among the pages included in said print image.

14. The image processing method according to claim 9, wherein when said input image includes a plurality of pages having different sizes, said displayed area includes an area in which the page included in said print image can be selected by the image size.

15. The image processing method according to claim 9, wherein when said input image includes a plurality of pages having different image directions, said displayed area includes an area in which the page included in said print image can be selected by the image direction.

16. The image processing method according to claim 9, wherein when said input image includes a color image and a monochrome image, said displayed area includes an area in which the color image and the monochrome image can be selected respectively among the pages included in said print image.

17. A computer-readable medium that stores an image processing program to be executed in a computer connected to an input device and a display, a processor of said computer, in response to commands from said program, executing the steps of
receiving setting relating to print output through said input device; and
displaying a print image when an input image is print-outputted in accordance with said setting, in said display; wherein
said step of displaying includes the step of displaying an area for selecting pages having specific attribute based on a content of said setting in common among pages included in said print image, in addition to said print image, and
said step of receiving includes the step of reflecting, in response to a user operation of said area, setting inputted subsequently after the operation of the relevant area on the corresponding pages.

18. The computer-readable medium that stores the image processing program according to claim 17, wherein said step of displaying further includes the step of redisplaying a print image in accordance with the setting inputted subsequently after the selection in said area.

19. The computer-readable medium that stores the image processing program according to claim 17, wherein said setting includes finishing setting for print-outputted paper.

20. The computer-readable medium that stores the image processing program according to claim 17, wherein said setting includes setting for assembling a plurality of pages included in said input image in a single page to print-out the same.

21. The computer-readable medium that stores the image processing program according to claim 17, wherein said displayed area includes an area in which an odd page and an even page can be selected respectively among the pages included in said print image.

22. The computer-readable medium that stores the image processing program according to claim 17, wherein when said input image includes a plurality of pages having different sizes, said displayed area includes an area in which the page included in said print image can be selected by the image size.

23. The computer-readable medium that stores the image processing program according to claim 17, wherein when said input image includes a plurality of pages having different image directions, said displayed area includes an area in which the page included in said print image can be selected by the image direction.

24. The computer-readable medium that stores the image processing program according to claim 17, wherein when said input image includes a color image and a monochrome image, said displayed area includes an area in which the color image and the monochrome image can be selected respectively among the pages included in said print image.
